(19) United States
(12) Patent Application Publication
(10) Pub. No.: US 2021/0040772 A1
(43) Pub. Date: Feb. 11, 2021

(54) DIGITAL DOOR LOCK, DOOR LOCK CONTROL SERVER, AND DOOR LOCK SYSTEM

(71) Applicant: Gil Soo KIM, Seoul (KR)

(72) Inventor: Gil Soo KIM, Seoul (KR)

(21) Appl. No.: 17/079,766

(22) Filed: Oct. 26, 2020

Related U.S. Application Data
(63) Continuation of application No. PCT/KR2019/005517, filed on May 8, 2019.

(30) Foreign Application Priority Data
Nov. 2, 2018 (KR) 10-2018-0133484
Dec. 25, 2018 (KR) 10-2018-0168842

(51) Int. Cl. E05B 17/22; G07C 9/00

(52) U.S. Cl. CPC E05B 17/226; E05B 2047/0067; G07C 9/00563

(57) ABSTRACT

A digital door lock, a digital door lock control server, and a digital door lock system are proposed. The digital door lock according to an embodiment of the present invention includes a driving unit formed in a door to move a deadbolt by an electric signal; a detection unit detecting whether the door is opened or closed; and controller configured to allow power to be provided from an external constant power supply when the deadbolt is drawn out of a body and is in contact with a power board inside a bracket formed in a door frame, and allow power to be provided from an internal power supply in the form of a primary battery or a secondary battery when the deadbolt is drawn into the body and is away from the power board.

### CROSS-REFERENCE TO RELATED APPLICATIONS

The present application is a continuation of International Patent Application No. PCT/KR2019/005517, filed May 8, 2019, which is based upon and claims the benefit of priority to Korean Patent Application Nos. 10-2018-0133484 filed on Nov. 2, 2018, and 10-2018-0168842 filed on Dec. 25, 2018. The disclosures of the above-listed applications are hereby incorporated by reference herein in their entirety.

### TECHNICAL FIELD

The present invention relates to a technology for supplying electricity through the deadbolt and, more particularly, to a technology for unlocking a door lock after an advertisement is exposed.

### BACKGROUND ART

A home door lock system plays a very important function, in terms of privacy protection, as a locking device to restrict visitors entering and exiting a house. A home door lock system commonly uses a key or a password in the related art. However, since such home door lock is vulnerable to a failure and has poor security, it is being transformed into a structure that is managed in an integrated manner via a network. In particular, when implementing a home door lock system via a network, it is very useful to manage the same in an integrated manner in facilities such as a large housing complex.

In recent years, technologies for remote control of a door lock have been actively developed. Among technologies, Korean Patent Registration No. 10-1249811 relates to “Home door lock system capable of remotely controlling opening and closing and a method thereof”, in which the opening and closing of an entrance door may be remotely controlled, whereby when someone visits the home, the owner of the home remotely unlocks the home door lock system through his or her mobile terminal registered in the home door lock system so that the visitor may enter the home.

However, the related art has limitations that the door lock consumes a lot of power due to various functions, and it is necessary to change the door and the door frame itself when installing the door lock.

Meanwhile, many people are using such a digital door lock due to the convenience thereof and because each home or office now generally has an Internet connection. However, in local advertisements, flyers are still distributed along with newspapers or manually distributed. Many advertising flyers are posted on doors, but most advertising flyers are simply discarded. This not only weakens the advertising effect, but also leads to waste of discarded flyers and consumption of printing costs and labor costs for distributing the flyers.

In order to improve this, among technologies, Korean Patent Application Publication No. 10-2009-0129164 (published on Dec. 16, 2009) relates to a door lock device equipped with an advertisement display device and an advertising method by connecting the device to the Internet, in which a technology for adding an advertisement display outside the door and an order display function inside the door to the door lock is disclosed.

However, the technology is to expose an advertisement when entering a door lock number, and thus have a limitation in that advertising effects cannot be enhanced because that advertisements are exposed in a relatively short time.

### DISCLOSURE

### Technical Problem

In order to solve the problem as described above, an objective of the present invention is to provide a digital door lock, which is capable of being easily installed and managed by supplying power of an external power supply connected in an adapter manner through a deadbolt.

In addition, another objective of the present invention is to provide a digital door lock, which is capable of being used in various door frame environments by changing the position of the power terminal according to the installation direction of the bracket installed on the door frame.

In addition, another objective of the present invention is to provide a digital door lock, which is capable of communicating with a user terminal to collect life information and then notify a user of the life information, thereby increasing convenience.

In addition, another objective of the present invention is to provide a digital door lock, in which the lock screen can be changed remotely, thereby enhancing the security.

In addition, another objective of the present invention is to provide a technology that outputs advertisement information using a door lock and provides a lock screen.

In addition, another objective of the present invention is to provide a technology that increases the advertisement effect by paying a predetermined reward means to users who view advertisement information.

In addition, another objective of the present invention is to provide a technology that provides analysis information on advertisement information to allow advertisers to check the effectiveness of the advertisements.

### Technical Solution

In order to achieve the above object, a digital door lock according to an embodiment of the present invention includes a driving unit formed in a door to move a deadbolt by an electric signal; a detection unit detecting whether the door is opened or closed; and a controller configured to allow power to be provided from an external constant power supply when the deadbolt is drawn out of a body and is in contact with a power board inside a bracket formed in a door frame, and allow power to be provided from an internal power supply in a form of a primary battery or a secondary battery when the deadbolt is drawn into the body and is away from the power board.

In addition, the bracket may be configured to have a first insertion hole into which the deadbolt is inserted formed on a first side surface, a second insertion hole into which the deadbolt is inserted formed on a second side surface perpendicular to the first side surface, and a plurality of partition walls formed inside, in which the partition wall is formed with a first seating groove in which the power board is seated to face the first insertion hole and a second seating groove in which the power board is seated to face the second insertion hole.

In addition, the controller may be configured to output a failure signal when power is not supplied from the constant power supply through the deadbolt or when power is not supplied from the internal power supply in a case that the door is locked.

In addition, the door lock may further include a communication unit communicating with an external user terminal or a management server, in which the controller may be configured to output life information including at least one piece of information of weather information, traffic information, and schedule information from the user terminal or the management server and, when the user approaches, update the living information.

In addition, the door lock may further include a communication unit communicating with an external user terminal or a management server; and a camera capturing an indoor space or an outdoor space, in which the controller may be configured to acquire an indoor or outdoor image using the camera when the door is closed, and acquire an indoor or outdoor image through the user terminal when the door is opened.

In addition, the door lock according to another embodiment of the present invention includes a detection unit detecting a person's approach; a display unit outputting advertisement information; and a controller configured to automatically output the advertisement information to the display unit when the person's approach is detected from the detection unit, and output a lock screen to the display unit when attempting to unlock the door lock.

In addition, the detection unit may detect the persons' approach using at least one of a motion detection sensor, a fingerprint sensor, and a contact sensor.

In addition, the door lock may further include a communication unit communicating with an external control server, in which the controller may be configured to receive an identification code from the control server and output the identification code to the lock screen and, when the user terminal obtains the identification code and transmits the same to the control server together with authentication information to be authenticated, unlock the door lock.

In addition, the door lock may further include a location providing unit providing location information of the door lock, in which the controller may be configured to update the advertisement information according to the location information of the door lock and output a reward means to the display unit.

In addition, a digital door lock control server according to another embodiment of the present invention includes a communication unit communicating with a door lock installed in a door; a detection information management unit acquiring detection information obtained by detecting a person's approach from the door lock; an advertisement information management unit managing advertisement information displayed on a display unit of the door lock; and a controller configured to output the advertisement information to the display unit when the person's approach is confirmed from the detection information and display a lock screen on the display unit when attempting to unlock the door lock.

In addition, the digital door lock control server may further include a reward unit paying a predetermined reward means to a user account of the door lock according to the number of times the advertisement information is provided, in which the controller is configured to pay a predetermined fee to the user account of the door lock when the advertisement information is terminated and the lock screen is released.

In addition, the advertisement information management unit may be configured to update the advertisement information according to the location information of the door lock and, when a user requests additional information about the advertisement information, provide an URL for the additional information to the user terminal.

In addition, the digital door lock control server may further include an analysis unit generating analysis information on a number of times the advertisement information is viewed and a location where the advertisement information is viewed and providing the analysis information to an advertiser.

A digital door lock system according to another embodiment of the present invention includes a digital door lock installed in a door; and a control server including a communication unit communicating with the door lock, a detection information management unit acquiring detection information obtained by detecting a person's approach from the door lock, an advertisement information management unit managing advertisement information displayed on a display unit of the door lock, and a controller configured to output the advertisement information to the display unit when the person's approach is confirmed from the detection information and display a lock screen on the display unit when attempting to unlock the door lock.

### Advantageous Effects

According to the present invention, it is possible to provide a digital door lock, which is capable of being easily installed and managed by supplying power of an external power connected in an adapter manner through a deadbolt.

In addition, it is possible to provide a digital door lock, which is capable of being used in various door frame environments by changing the position of the power terminal according to the installation direction of the bracket installed on the door frame.

In addition, it is possible to increase convenience, by communicating with a user terminal to collect life information and then notifying a user of the life information.

In addition, the lock screen can be changed remotely, thereby enhancing the security.

In addition, it is possible to increase the advertisement effect by outputting advertisement information using a door lock and providing a lock screen.

In addition, it is possible to increase the advertisement effect by paying a predetermined reward means to users who view advertisement information.

In addition, it is possible to provide analysis information on advertisement information to allow advertisers to check the effectiveness of the advertisements.

### DESCRIPTION OF DRAWINGS

FIG. 1 is a configuration diagram showing a digital door lock system.

FIGS. 2A and 2B are configuration diagrams showing a digital door lock according to an embodiment of the present invention.

FIGS. 3A and 3B are detailed configuration diagrams showing the advance and withdrawal of the deadbolt in the digital door lock according to FIGS. 2A and 2B.

FIGS. 4A and 4B are exemplary views showing the positions of the digital door lock and bracket according to FIGS. 2A and 2B.

FIGS. 5A and 5B are detailed configuration diagrams showing a bracket connected to the digital door lock according to FIGS. 2A and 2B.

FIGS. 6A and 6B are exemplary views showing a lock screen and life information output through a display unit of the digital door lock according to FIGS. 2A and 2B.

FIG. 7 is an exemplary diagram showing how an image is obtained from the digital door lock according to FIGS. 2A and 2B.

FIG. 8 is an exemplary view showing living information provided through the display unit in the digital door lock according to FIGS. 2A and 2B.

FIG. 9 is a block diagram showing a door lock system according to another embodiment of the present invention.

FIG. 10 is a schematic configuration diagram showing a door lock for advertisement according to another embodiment of the present invention.

FIGS. 11A and 11B are exemplary views showing advertisement information and a lock screen output from the door lock for advertisement according to FIG. 10.

FIG. 12 is a schematic configuration diagram showing a door lock control server for advertisement according to an embodiment of the present invention.

FIG. 13 is an exemplary view showing identification codes of a door lock and a user terminal recognized by the door lock control server for advertisements according to FIG. 12.

### MODE FOR INVENTION

Hereinafter, embodiments of the present invention will be described in detail with reference to the accompanying drawings. The terms used are selected in consideration of functions in the embodiments, and the meaning of the terms may vary according to the intentions or precedents of users or operators. Therefore, meanings of the terms used in embodiments to be described later are specifically defined in the present specification, and when the meaning is not specifically defined, it should be interpreted as meaning generally recognized by those skilled in the art.

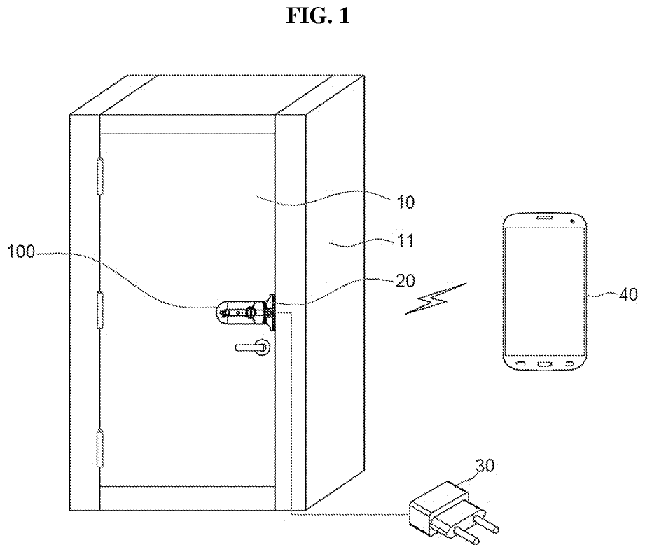

FIG. 1 is a configuration diagram showing a digital door lock system.

Referring to FIG. 1, the door lock system includes a door 10, a door frame 11, a bracket 20, an adapter 30, and a digital door lock 100. The door 10 is a hinged door made of metal or wood and thus is configured to rotate in a state where one side thereof is fixed to the door frame 11 by a hinge structure, but is not limited thereto and may be configured in a folding method and a sliding method. The door 10 may be provided with a handle separate from the digital door lock 100.

The door frame 11 is a frame formed to be spaced apart from the outer surface of the door 10, and has a bracket 20 installed. The door frame 11 may be formed parallel to the door 10 or formed to protrude from the door 10. When the door frame 11 is formed parallel to the door 10, the bracket 20 is installed in an outer surface of the door frame 11, and when the door frame 11 is formed to protrude from the door 10, the bracket 20 is installed in an inner side of the door frame 11.

The bracket 20 serves to keep a deadbolt 111 of the digital door lock 100 inserted and fixed therein. Herein, the bracket 20 may be installed in the door frame 11 in two directions. For example, the bracket 20 is installed in the door frame 11 so as to be parallel to the direction in which the deadbolt 111 of the door lock 100 is withdrawn, or be installed in the door frame 11 so as to be perpendicular to the direction in which the deadbolt 111 is withdrawn. A power board 31 is formed inside the bracket 20 so that power may be supplied from an external constant power supply through the deadbolt 111.

The adapter 30 is detachably connected to the power board 31 inserted into the bracket 20, and serves to supply power form the external constant power supply. Herein, the adapter 30 is connected to the power board 31 inside the bracket 20 to supply power to the digital door lock 100 through the deadbolt 111. The adapter 30 is detachably connected to the power board 31, and thus may be easily installed without arranging wiring separately inside the door 10 or the door frame 11. In addition, the power board 31 may supply power to the deadbolt 111 in a wireless manner. Herein, it is also possible to supply wireless power along an outer circumferential surface of the deadbolt 111.

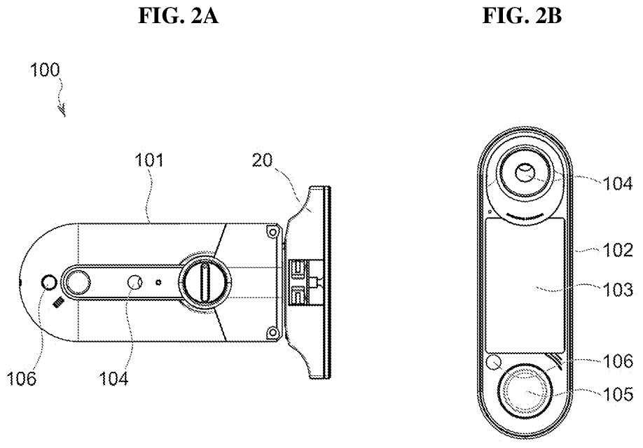

The digital door lock 100 is formed at both sides of the door 10. The digital door lock 100 may be operated by user's manipulation or by communication with the user terminal 40. The digital door lock 100 is provided so that the deadbolt 111 is drawn out by an electric signal and inserted into the bracket 20. Herein, the digital door lock 100 may be driven by receiving power from an external constant power supply through the deadbolt 111 or driven through an internal power supply 113. Herein, the internal power supply 113 may be implemented in the form of a primary battery or a secondary battery. The digital door lock 100 may be remotely controlled through communication with an external user terminal 40. Hereinafter, the digital door lock 100 will be described in detail with reference to FIGS. 2A to 5B.

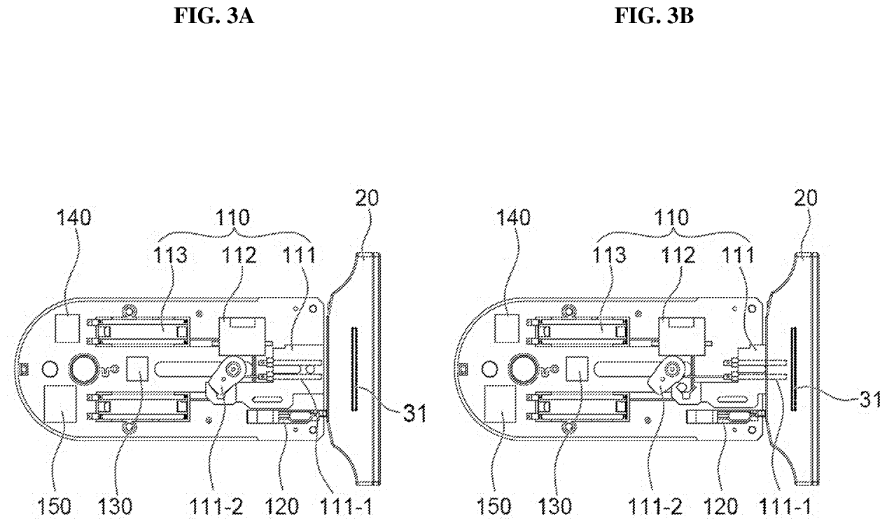

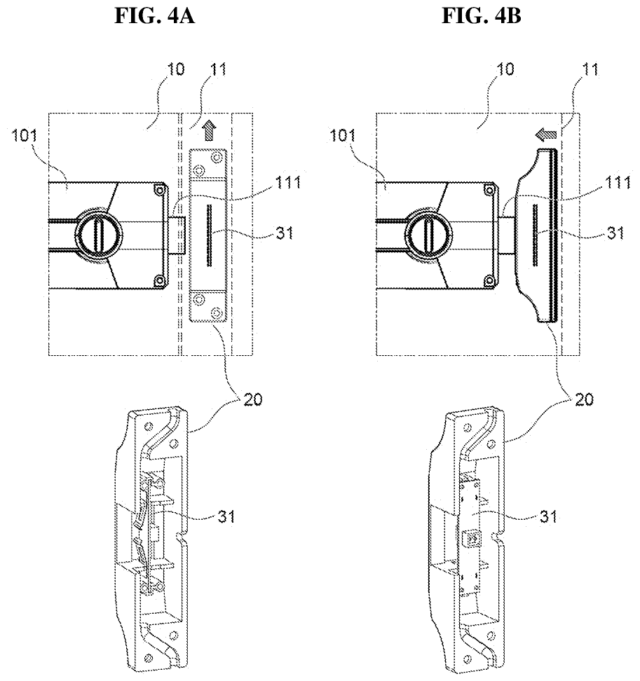

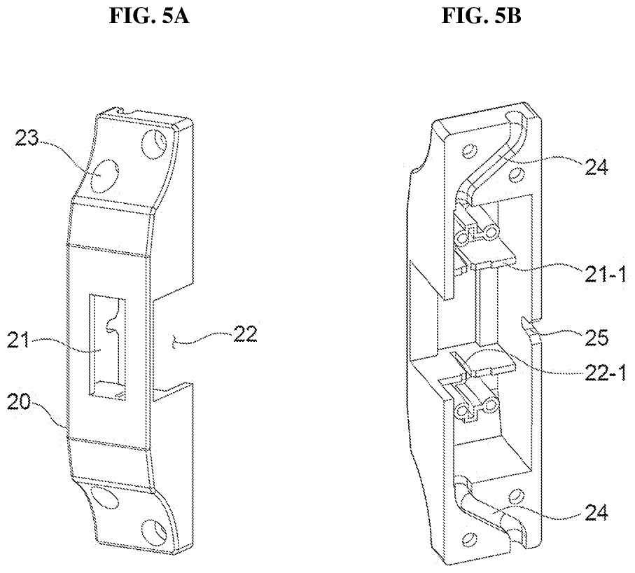

FIGS. 2A and 2B are configuration diagrams showing a digital door lock according to an embodiment of the present invention; FIGS. 3A and 3B are detailed configuration diagrams showing the advance and withdrawal of the deadbolt in the digital door lock according to FIGS. 2A and 2B; FIGS. 4A and 4B are exemplary views showing the positions of a digital door lock and a bracket according to FIGS. 2A and 2B; and FIGS. 5A and 5B are detailed configuration diagrams showing a bracket connected to the digital door lock according to FIGS. 2A and 2B.

Referring to FIGS. 2A to 5B, the door lock 100 according to an embodiment of the present invention has a first body 101 formed on one surface of the door 10 and a second body 102 formed on the other surface of the door 10, the first body 101 and the second body 102 being combined with each other with the door 10 in between. The first body 101 may be formed with a driving unit 110, a detection unit 120, and a controller 230. The second body 102 may be formed with a display unit 103, a camera 104, a communication pad 105, a human body sensor 106, and the like. In addition, the first body 101 may be also formed with at least one of the display unit 103, the camera 104, the communication pad 105, and the human body sensor 106. Herein, the first body 101 is used indoors, and the second body 102 is used outdoors. The first body 101 is formed in parallel with the bracket 20 fixed to the door frame 11. The position of the bracket 20 may vary depending on the width of the door frame 11. The bracket 20 may be formed on a first side of the door frame 11 so as to face the door 10, or may be formed on a second side of the door frame 11 in a vertical direction to the door 10.

The driving unit 110 is formed on one side of the door 10 to allow the deadbolt 111 to be moved by an electric signal. The driving unit 110 includes an electric motor 112 and a deadbolt 111. The driving unit 110 may receive power from the external constant power supply through the deadbolt 111 or may receive power from the internal power supply 113 such as a removable battery. Herein, the internal power supply 113 may use a primary battery or a secondary battery. The deadbolt 111 has one side thereof formed of a rectangular parallelepiped member and a driving electrode 111-1 formed therein. The deadbolt 111 may be formed of an insulating high-strength synthetic resin material. The deadbolt 111 is advanced or withdrawn by the electric motor 112. When the deadbolt 111 is advanced, the deadbolt 111 is inserted into the bracket 20 formed in the door frame 11 to prevent the door 10 from opening. When the deadbolt 111 is withdrawn, the deadbolt 111 is separated from the bracket 20 and is drawn into the first body 101 to allow the door 10 to open.

FIG. 3A shows a state in which the deadbolt 111 is drawn into the first body 101 and thus driven by the internal power supply 113. FIG. 3B shows a state in which the deadbolt 111 is drawn out of the first body 101 to be in contact with the power board 31 inserted into the bracket 20 and thus driven by an external power supply. Another side of the deadbolt 111 is connected to a rotating unit 111-2, and the rotating unit 111-2 is connected to the electric motor 112. The driving unit 110 moves the deadbolt 111 as the electric motor 112 rotates the rotating unit 111-2 by an electric signal.

FIG. 4A shows a case where the bracket 20 is installed in a first direction, and FIG. 4B shows a case where the bracket 20 is installed in a second direction. In the case of view (a), the door 10 and the door frame 11 are located side by side on the plane. Herein, the digital door lock 100 is installed in the door 10, and the bracket 20 is installed in a first direction, which is arranged in an outer side of the door frame 11. The power board 31 is inserted into the bracket 20, and is connected to an external adapter 30. The deadbolt 111 of the digital door lock 100 is drawn out of the first body 101 to be introduced into the bracket 20, and is in contact with the power board 31 to receive external power.

In the case of the view (b), the door frame 11 is located to protrude from the plane of the door 10. Herein, the bracket 20 is installed in the second direction, which is arranged in an inner side of the door frame 11. The power board 31 is inserted into the bracket 20 in a direction perpendicular to the case of view (a), and the power board 31 is connected to the external adapter 30. The deadbolt 111 of the digital door lock 100 is drawn out from the first body 101 to be introduced into the bracket 20, and is in contact with the power board 31 to receive external power. In this way, the installation direction of the bracket 20 and the insertion position of the power board 31 are varied depending on the positions of the door 10 and the door frame 11, so that the installation is easy.

FIG. 5A represents the outside of the bracket 20, and FIG. 5B represents the inside of the bracket 20. The outside of the bracket 20 includes a first insertion hole 21, a second insertion hole 22, and a bolt hole 23. The first insertion port 21 is a hole into which the deadbolt 111 is inserted. The first insertion hole 21 is formed on the first side of the bracket 20. When the bracket 20 is formed on the inner side of the door frame 11, the deadbolt 111 is inserted into the first insertion hole 21. The second insertion hole 22 is another hole into which the deadbolt 111 is inserted. The second insertion hole 22 is formed on the second side of the bracket 20. When the bracket 20 is formed on the outer surface of the door frame 11, the deadbolt 111 is inserted into the second insertion hole 22. Herein, the first insertion opening 21 and the second insertion opening 22 are formed orthogonal to each other. Accordingly, the direction in which the deadbolt 111 is inserted may vary depending on the installation position of the bracket 20. The bolt hole 23 is a hole into which a bolt is inserted. The bolt is inserted into the bolt hole 23 to fix the bracket 20 to the door frame 11.

The inside of the bracket 20 includes a first seating groove 21-1, a second seating groove 22-1, a first wire groove 24, and a second wire groove 25. The first seating groove 21-1 is a groove in which the power board 31 is seated. The first seating groove 21-1 is formed in an inner partition wall to face the first insertion hole 21 so that the front tip of the deadbolt 111 is connected to the power board 31 when the deadbolt 111 is inserted through the first insertion port 21. The second seating groove 22-1 is another groove in which the power board 31 is seated. The second seating groove 22-1 is formed in an inner partition wall to face the second insertion hole 22 so that the front tip of the deadbolt 111 is connected to the power board 31 when the deadbolt 111 is inserted through the second insertion hole 22. Herein, the first seating groove 21-1 and the second seating groove 22-1 are formed orthogonal to each other.

The first wire groove 24 is a groove for fixing the electric wire of the adapter 30. The first wire groove 24 is formed on each of both inner sides of the bracket 20. This is to facilitate wiring of the electric wire of the adapter 30 according to the installation position of the bracket 20. The second wire groove 25 is another groove which is formed in one side of the bracket 20 to fix the electric wire. Accordingly, the first wire groove 24 and the second wire groove 25 are formed on the bottom surface of the bracket 20 so that wiring of the electric wire of the adapter 30 is possible in various positions. In addition, the first wire groove 24 and the second wire groove 25 may fix the electric wire of the adapter 30 to prevent the wire from being removed.

The detection unit 120 is implemented as a contact or non-contact sensor to sense whether the door 10 is opened or closed. When the detection unit 120 is implemented as a contact sensor, the detection unit 120 is formed to protrude to the outside of the first body 101. The detection unit 120 is provided in such a manner as to be in contact with the door frame 11 when the door 10 is closed, and not in contact with the door frame 11 when the door 10 is opened. The detection unit 120 senses whether the door 10 is opened or closed according to whether the door 10 is in contact with the door frame 11, and generates a detection signal for determining whether the digital door lock 100 receives power from an external power supply or an internal power supply 113 to output the same to the controller 230.

In addition, the detection unit 120 may be implemented as a non-contact sensor such as an infrared sensor, an illuminance sensor, and a magnetic sensor to sense whether the door 10 is opened or closed. In addition, the detection unit 120 may be formed with both the contact sensor and the non-contact sensor. For example, a first detection signal relating to whether the door 10 is opened or closed may be generated through the contact sensor, and a second detection signal relating to whether the door 10 is opened or closed may be generated through the non-contact sensor. This is to determine whether the detection unit 120 has a failure. When the first detection signal and the second detection signal are different from each other, such as a case that the first detection signal indicates a state in which the door 10 is open and the second detection signal indicates a state in which the door 10 is closed, or vice versa, it may be determined that the detection unit 120 has a failure.

The controller 130 is implemented as at least one microcontroller unit (MCU) on a circuit board. Herein, the controller 130 may be formed on the first body 101 or the second body 102. The controller 130 may move the deadbolt 111 according to an electric signal to control whether or not the door 10 is opened or closed. The controller 130 switches to receive power from an external constant power supply when the deadbolt 111 is drawn out of the main body and thus is in contact with the power board 31 inside the bracket 20 formed in the door frame 11. The controller 130 receives power from the internal power supply 113 when the deadbolt 111 is introduced into the body to be not in contact with the power board 31. Herein, the controller 130 shifts the voltage level of the electric signal when switching the power supply source between the constant power supply and the internal power supply 113, thereby preventing a power failure of the digital door lock 100.

In addition, the controller 130 outputs a failure signal when constant power is not supplied through the deadbolt 111 and power is not supplied from the internal power supply 113, in the case that the door 10 is closed. The controller 130 may determine whether the door 10 is opened or closed through the detection unit 120. Herein, even when the door 10 is closed, a failure signal is output when external constant power is not supplied. In addition, when the internal power supply 113 is configured as a rechargeable battery, a failure signal is output when the constant power is not charged to the internal power supply 113. The failure signal may be transmitted to the user terminal 40 or output as an alarm sound.

In addition, the controller 130 compares a first detection signal for detecting whether the door is open or closed through the detection unit 120, and a second detection signal for detecting whether a driving electrode 111-1 of the deadbolt 111 is in contact with the power terminal of the power board 31, and output a failure signal when the first signal and the second signal do not match with each other. The failure signal may be transmitted to the user terminal 40 or output as an alarm sound.

In addition, when the detection unit 120 is implemented with a contact sensor and a non-contact sensor, the controller 130 may output a failure signal even when the first detection signal of the contact sensor and the second detection signal of the non-contact sensor do not match with each other. The failure signal may be transmitted to the user terminal 40 or output as an alarm sound.

In addition, the controller 130 may check the power remaining amount state of the internal power supply. When the door 10 is closed, the controller 130 may send an electric signal to the internal power supply using a constant power supplied from the outside to determine the power remaining amount state. When the internal power supply is implemented as a secondary battery, the controller 130 may sense the deterioration of the charge/discharge performance. The controller 130 may identify the characteristic voltage for the internal power supply in the form of a secondary battery to determine the charging performance. The controller 130 may output a failure signal when the charging performance of the internal power supply in the form of a secondary battery is less than or equal to a predetermined value.

Meanwhile, the digital door lock 100 according to an embodiment of the present invention may further include a communication unit 140 and a sound unit 150.

The communication unit 140 communicates with an external user terminal 40 or a management server. The external user terminal 40 is a concept encompassing a fixed or mobile terminal used by a user. The communication unit 140 may output a detection signal relating to whether the door 10 is opened or closed to the user terminal 40 through a network, or may output information on the power remaining amount of the internal power supply 113 of the digital door lock 100. In addition, the communication unit 140 may acquire an indoor or outdoor image through the camera 104 formed in the first body 101 or the second body 102 and transmit the same to the user terminal 40. In addition, the communication unit 140 may receive a control signal remotely from the user terminal 40 and output the same to the controller 130. Accordingly, the user may remotely open/close the door lock 100 or check an indoor or outdoor situation.

The sound unit 150 detects surrounding sound. The sound unit 150 may identify an indoor or outdoor user through frequency analysis. The sound unit 150 operates in a sleep mode and, when a frequency of a predetermined amount or higher is detected, changes into a start mode to detect the frequency. The sound unit 150 may transmit the sound information to the external user terminal 40 through the communication unit 140. Herein, when the surrounding sound is detected, the controller 130 compares a frequency of the surrounding sound with that of a predetermined visitor's sound to identify information on the visitor and outputs the same to the external user terminal 40 or a management server. Herein, it is preferable that frequency information on sound of each visitor is preset in the user terminal 40 or the management server. Accordingly, it is possible to distinguish between a visitor and an internal resident from a remote location.

Meanwhile, the controller 130 receives at least one of a keypad input, a pattern input, and a question-and-answer input through the display unit 103 formed in the first body 101 or the second body 102 to provide a lock screen. When a code consisting of a combination of symbols and characters set by the user is input through the display unit 103, the controller 130 may unlock the digital door lock 100. When a gesture pattern set by the user is input through the display unit 103, the controller 130 may unlock the digital door lock 100. When a quiz in a question-and-answer format is provided through the display unit 103, and an answer is inputted from the user, the controller 130 may unlock the digital door lock 100. The lock screen may be randomly changed by the user. Since various lock screens may be provided, it is possible to reduce a risk of shoulder surfing by others and induce interest to the user.

In addition, the controller 130 may output an identification code through the display unit 103 formed in the first body 101 or the second body 102. Herein, the display unit 103 may be implemented as a touch display to output symbols, characters, figures, and the like. The controller 130 receives an identification code randomly changed at a predetermined period of time from the management server and outputs the identification code to the display unit 103 when the user terminal 40 approaches. The identification code may be implemented as a one-dimensional barcode, a two-dimensional barcode, or the like, but is not limited thereto. When the user terminal 40 obtains the identification code and thus is authenticated by the management server, the deadbolt 111 may be drawn into the body to release the lock state. Accordingly, the user may identify the user in such a manner as to directly input a password through the display unit 103 of the digital door lock 100 or in a non-contact manner without recognizing a fingerprint. The identification code is encrypted and managed by the management server, and the information is randomly changed at a predetermined period of time.

In addition, when the user's approach to the door is sensed using the human body sensor 106 formed in the first body 101 or the second body 102, the controller 130 may capture the user with the camera 104 formed in the first body 101 or the second body 102 and transmit the capturing result to the user terminal 40. The controller 130 detects infrared rays to check whether the user is approaching the door, and captures the human body of the user and transmits the capturing result to the user terminal 40 in a form of a push alarm. The controller 130 communicates with a remote camera formed indoors to allow a function of the camera 104 formed in the digital door lock 100 to be turned off and the indoor remote camera to be turned on when the door 10 is open. This is to monitor the indoor situation and persons entering and leaving the room through the remote camera 40, since the camera 104 of the digital door lock 100 cannot properly capture indoor situation when the door 10 is opened.

In addition, the controller 130 may access an external weather server, an Internet server, and the like to display life information such as weather information and schedule information on the display unit 103 of the digital door lock 100. Accordingly, when the user approaches the digital door lock 100, the human body sensor 106 detects the user's approach so that the user may check the current weather or schedule through the display unit 103. Herein, the controller 130 may be linked to external traffic information and the like to output the same to the display unit 103 of the digital door lock 100. The controller 130 may communicate with the user terminal 40 or may directly communicate with an external server to obtain public data such as weather information, schedule information, traffic information, and the like. The controller 130 may output such information as a voice through a speaker to notify the user of the information.

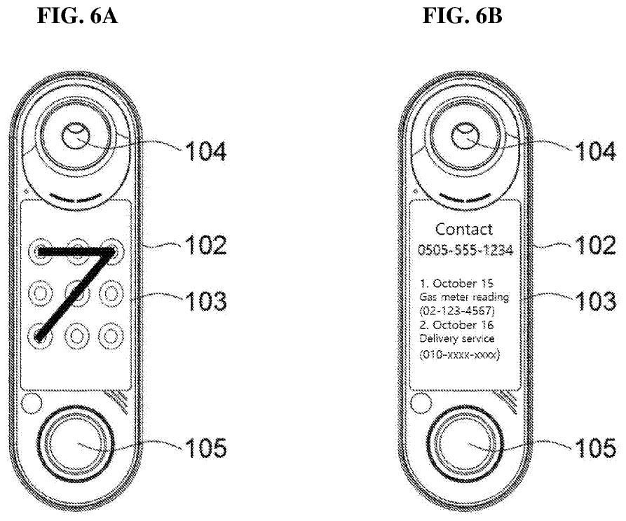

FIGS. 6A and 6B are exemplary views showing a lock screen and life information output through a display unit 103 of the digital door lock according to FIGS. 2A and 2B.

FIG. 6A shows that a lock screen is provided through the display unit 103. A display unit 103 is formed on the second body 102, exposed to the outside, of the digital door locks 100, and a preset lock screen is displayed through the display unit 103. Herein, a user may remotely change a type of a lock screen through his or her user terminal 40. The lock screen may be formed in various ways such as a key button input, a pattern input, and a question-and-answer input. The lock screen may be set by the user or changed randomly, and thus not easily exposed to a third party, thereby enhancing security. Herein, it is preferable that the user sets multiple pieces of unlocking information. The second body 102 of the digital door lock 100 may be installed with a camera 104, a communication pad 105, and the like. An outdoor image may be obtained through the camera 104, and the door lock 100 may be unlocked by contacting an NFC electronic tad through the communication pad 105.

FIG. 6B indicates that living information is output through the display unit 103. A safe number previously set by the user may be displayed on the display unit 103. Herein, the safe number may be randomly changed over time and may be exposed when any visitor calls. When a visitor leaves a message, such as a text message or SNS, through the safe number, the digital door lock 100 stores the message and outputs the message to the display unit 103. Herein, it is also possible to separately provide the message to the user terminal 40 through a push alarm or the like. When the user arrives at home, the user may check information of the visitors who left the message during his/her absence through the display unit 103.

In addition, preset advertisement content may be exposed on the display unit 103 of the digital door lock 100. Herein, the advertisement content is changed at a predetermined period of time. The digital door lock 100 may expose the advertisement content when any person approaches the door. The advertisement content may be provided through the display unit 103 and a speaker. When the user attempts to unlock the door lock 100, the advertisement content is exposed first, and when the user has unlocked the door lock 100, predetermined points are accumulated to the account of the user terminal 40.

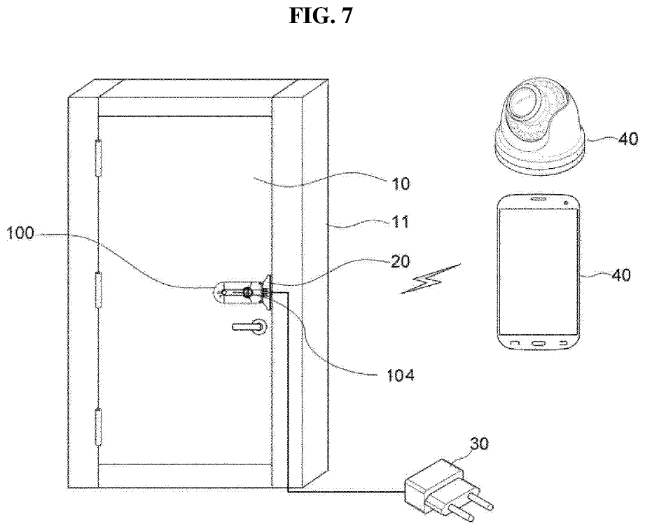

FIG. 7 is an exemplary diagram showing how an image is obtained from the digital door lock according to FIGS. 2A and 2B.

Referring to FIG. 7, the digital door lock 100 may enable an indoor image to be acquired through an external user terminal 40. The digital door lock 100 includes a camera 104, and the camera captures an indoor space in real time and transmits the captured image to the external user terminal 40 when a deadbolt 111 is connected to a bracket 20 and the external power is supplied. When the digital door lock 100 is unlocked so that the deadbolt 111 is separated from the bracket 20, the camera 104 of the digital door lock 100 stops operating. Herein, an indoor space is captured through the external user terminal 40. The user terminal 40 may use an IP camera, in addition to a personal portable terminal such as a smartphone. Therefore, when the door is opened so that the camera 104 may not properly capture the indoor space, continuous capturing is possible by capturing the indoor space using a personal portable terminal or an IP camera.

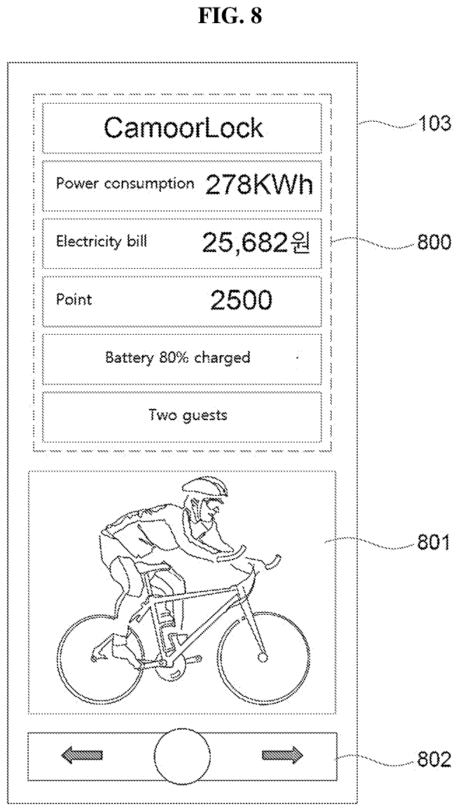

FIG. 8 is an exemplary view showing living information provided through a display unit of the digital door lock according to FIGS. 2A and 2B.

Referring to FIG. 8, at least one of life information 800, advertisement content 801, and a lock interface 802 may be output on the display unit of the digital door lock according to an embodiment of the present invention. The living information 800 may output information such as power usage, electric charges, points, and charging status. In addition, the living information 800 may output a weather forecast, a memo, a schedule, and the like. The living information 800 may be updated when the digital door lock detects a human body's approach.

The advertisement content 801 may be stored in advance or may be received from an external advertisement server. The advertisement content 801 outputs advertisements of nearby businesses at a predetermined period of time on the basis of an installation location of the digital door lock. This is to use the digital door lock as a billboard. Herein, a predetermined fee may be settled according to the advertisement content exposure and paid to a user account of the digital door lock. The advertisement content may be provided including video, audio, and the like. The advertisement content may be set in such a manner as to be exposed only when detecting a human body's approach.

The lock interface 802 releases the lock screen through a touch input. The life information 800 or advertisement content is firstly formed on the lock screen, and when releasing the lock screen, an additional interface through which a password is input may be exposed. Herein, when the lock interface 802 is released, the predetermined points may be accumulated to the user's account. The points are rewards for checking the advertising content on the lock screen. Accordingly, it is possible to provide the advertisements through the lock screen, and to provide economic cost benefits to users by paying the predetermined fee.

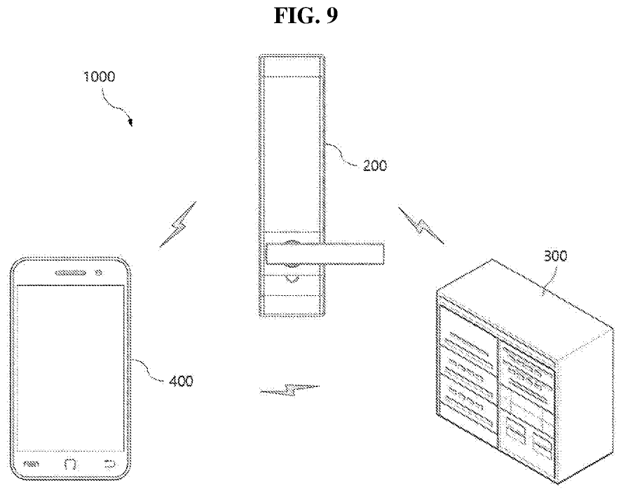

FIG. 9 is a block diagram showing a door lock system according to another embodiment of the present invention.

Referring to FIG. 9, a door lock system 1000 according to an embodiment of the present invention includes a digital door lock 200 and a digital door lock control server 300.

The digital door lock 200 is installed on the door to lock or unlock the door. The digital door lock 200 electronically locks or unlocks the door using a deadbolt. A display unit 220 is formed on the door lock 100 to output advertisement information. The digital door lock 200 may detect a person's approach by using at least one of a motion sensor, a fingerprint sensor, and a contact sensor. The digital door lock 200 outputs the advertisement information set in advance when a person approaches. The digital door lock 200 outputs the lock screen after the advertisement information is displayed. When the user unlocks the lock screen, the digital door lock 200 is released. The digital door lock 200 may be driven by an external power supply or an internal power supply to communicate with the control server 200.

The digital door lock control server 300 communicates with the digital door lock 200 to obtain detection information from the digital door lock 200 and to output the advertisement information. The digital door lock control server 300 may be connected to and communicate with an external Internet server and a financial server. The digital door lock control server 300 may receive the advertisement information from an advertiser or may receive advertisement information from an administrator of the digital door lock 200. The digital door lock control server 300 pays a fee according to the number of time or the period of time that the advertisement information is viewed to a user account of the digital door lock 200. The digital door lock control server 300 communicates with the digital door lock 200 at a predetermined period of time to update the advertisement information and pay a reward means. The digital door lock control server 300 may manage applications installed in a user terminal or an advertisement terminal.

Meanwhile, the door lock system 1000 according to an embodiment of the present invention may further include a user terminal 400. The user terminal 400 communicates with the digital door lock 200 and the digital door lock control server 300. When a user watches the advertisement information output to the door lock 200, the user terminal 400 may receive the reward means by way of compensation for the user watching the advertisement information. The user terminal 400 may include a plurality of user accounts and communicate with the door lock 100 or the control server 200. The user terminal 400 may obtain an identification code displayed on the door lock 200. The user terminal 400 may remotely change the advertisement information via the control server 200.

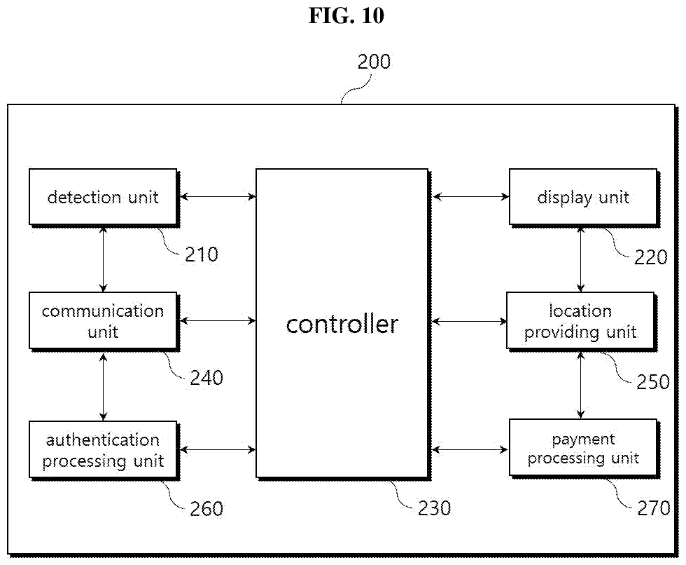

FIG. 10 is a schematic configuration diagram showing a door lock for advertisement according to another embodiment of the present invention.

Referring to FIG. 10, the digital door lock 200 according to an embodiment of the present invention includes a detection unit 210, a display unit 220, and a controller 230.

The detection unit 210 detects a person who approaches the door lock 200. For example, the detection unit 210 may be formed with at least one of a motion detection sensor, a fingerprint sensor, a contact sensor, and a sound sensor, but is not necessarily limited thereto. The detection unit 210 detects whether a person approaches the door lock 200 in real time, and turns on the display unit 220 of the door lock 200 when the person approaches. This is to output advertisement information through the display unit 220. The detection unit 210 outputs detection information to the controller 230.

The display unit 220 is formed of a liquid crystal such as LCD and OLED to output symbols, characters, figures, images, and the like. Herein, it is preferable that the display unit 220 is capable of touch input. Pre-set advertisement information is displayed on the display unit 220. The advertisement information is set by the advertiser and may be stored in an internal memory or may be periodically updated from an external control server. A lock screen is displayed on the display unit 220. The lock screen refers to a screen through which a number key and a pattern may be input to unlock the door lock 200. The lock screen may be output together with the advertisement information or output after the advertisement information.

The controller 230 outputs the advertisement information to the display unit 220 when a person's approach is detected from the detection unit 210. Herein, the advertisement information may include an advertisement of an advertiser located close to the location of the door lock 200. The time when the advertisement information is displayed may be set differently according to user settings. The controller 230 outputs the advertisement information and then outputs the lock screen to the display unit 220 when the user attempts to unlock the door lock 200. The controller 230 unlocks the door lock 200 by performing the unlocking procedure through the lock screen.

Meanwhile, the digital door lock 200 according to an embodiment of the present invention further includes a communication unit 240.

The communication unit 240 communicates with an external control server. The communication unit 240 is capable of communication with the control server through a wired or wireless network. The communication unit 240 transmits detection information, etc. detected by the door lock 200 and receives a control signal from the control server. The communication unit 240 may communicate encrypted information including unique information of the door lock 200. The communication unit 240 transmits detection information to the control server at a predetermined period of time, and receives a control signal to the detection information. The communication unit 240 is capable of communication using a home network in which the door lock 200 is installed. The communication unit 240 may be connected to and communicate with an external mobile communication server or an Internet server.

In addition, the communication unit 240 is capable of communicating with a user terminal. The user terminal is a mobile terminal used by the user and is preferably capable of network communication. The user terminal may include a keypad, a touch screen, an illuminance sensor, a fingerprint sensor, a position sensor, and the like. The communication unit 240 may also receive authentication information transmitted from the user terminal. Herein, a preset application used to access the control server may be installed in the user terminal. The communication unit 240 is capable of interactive communication with the control server and the user terminal. Reward means such as points, coupons, and cash are paid to the account of the user terminal.

Herein, the controller 230 receives an identification code from the control server and outputs the same to the lock screen. Here, the identification code may be formed in a form such as a barcode, a QR code, or an AR code, but is not limited thereto. The controller 230 unlocks the door lock 200, when the user terminal acquires an identification code and transmits the same to the control server together with the authentication information to be authenticated. Accordingly, the user may perform the unlocking procedure through his/her user terminal without contacting the door lock 200, thereby preventing the password of the door lock 200 from being leaked.

Meanwhile, the digital door lock 200 according to an embodiment of the present invention may further include a location providing unit 250.

The location providing unit 250 generates the location information of the door lock 200 using GPS or a network and outputs the same to the controller 230. The location providing unit 250 may receive local information previously registered in the door lock control server for advertisements using an application installed in the user terminal from the communication unit 240 and output the same to the controller 230. The location providing unit 250 receives advertisement information according to the location information of the door lock 200, and updates the advertisement information when the location information is changed. This is to update the advertisement information when the user moves and thus reinstalls the door lock 200 that was previously used. Herein, the controller 230 updates the advertisement information according to the position of the door lock 200, and outputs a reward means to the display unit 220 by way of compensation for the user watching each advertisement information. The reward means is used in a comprehensive sense, including cash, points, coupons, and virtual currency. In addition, when the controller 230 may expose the reward means to the display unit 220, the reward means is capable of being obtained through the user terminal to make it available to the user.

Meanwhile, the digital door lock 200 according to an embodiment of the present invention may further include a location providing unit 250.

The authentication unit 260 authenticates the user terminal. When the user terminal approaches the door lock 200, the display unit 220 may output an identification code or sound wave information. The user terminal first acquires the identification code and secondly acquires the sound wave information to output the same to an external control server. The authentication unit 260 determines whether the identification code and sound wave information acquired by the user terminal from the control server are authenticated. Herein, the authentication unit 260 may receive authentication information obtained by matching a unique number of a user terminal with the identification code and sound wave information. When the authentication is completed, the controller 230 unlocks the door lock 200.

Meanwhile, the digital door lock 200 according to an embodiment of the present invention may further include a payment processing unit 270. The payment processing unit 270 may be connected to an external payment server to perform payment processing for products included in the advertisement information. The payment processing unit 270 may process payment using a plastic card reader, an RF reader, or a mobile payment method, but is not limited thereto. Herein, the controller 230 may set in such a manner as to expose the lock screen to the door lock when payment processing is completed by the payment processing unit 270. A user checks product advertisements in advance through the door lock installed in unmanned convenience stores, unmanned cafes, unmanned vending machines, and the like, enters a payment means, and then unlocks the door lock to enter the indoor space. After the user purchases a product inside, the user acquires and recognizes a barcode of the product through the user terminal and processes the secondary payment through the payment processing unit 270, thereby completing the final payment.

In addition, when the user performs payment processing for products included in the advertisement information, the payment processing unit 270 may create order information to be delivered to the location information of the door lock. The controller 230 may receive the order information and delivery information from the control server and transmit the information to the user terminal.

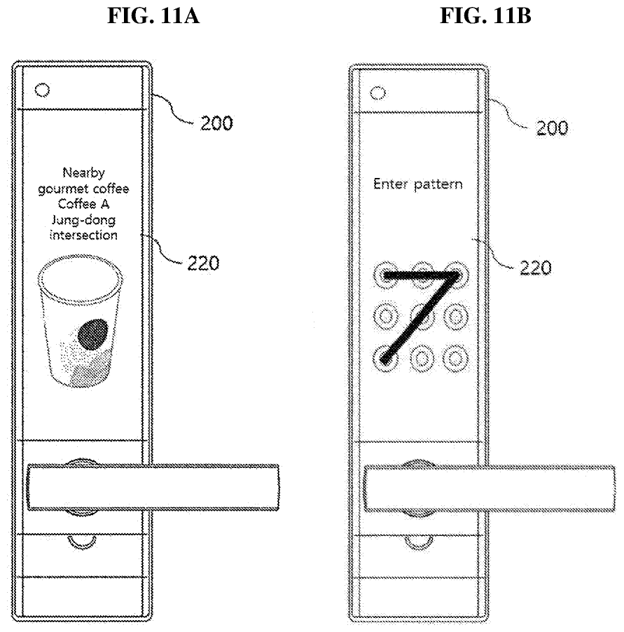

FIGS. 11A and 11B are exemplary views showing advertisement information and a lock screen output from the door lock for advertisement according to FIG. 10.

FIG. 11A indicates that advertisement information is output when a person is detected by the door lock 200. Herein, the advertisement information of an advertiser is output for a predetermined time or longer. When the door lock 200 is unlocked, the advertisement information is set in such a manner as to be converted to the next advertisement after counting the predetermined time. FIG. 11B shows that the lock screen is displayed on the door lock 200. The lock screen is capable of user's biometric information input, in addition to pin number input and pattern input. When the user pattern is input to the lock screen, the door lock 200 is unlocked.

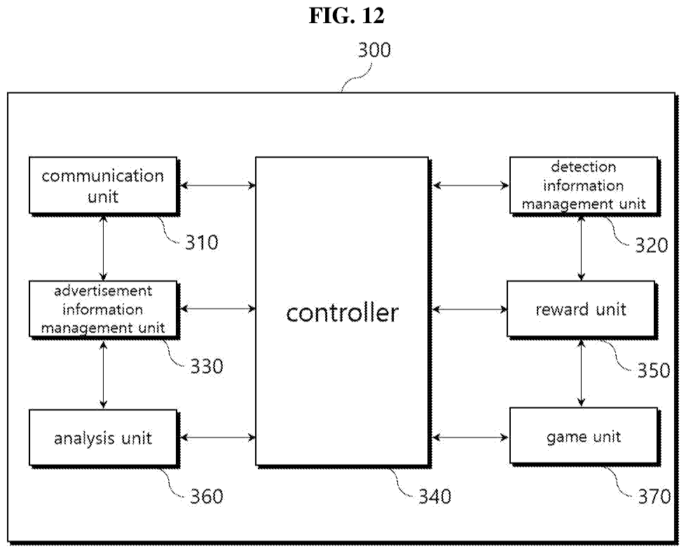

FIG. 12 is a schematic configuration diagram showing a door lock control server for advertisement according to an embodiment of the present invention.

Referring to FIG. 12, a digital door lock control server 300 according to an embodiment of the present invention includes a communication unit 310, a detection information management unit 320, an advertisement information management unit 330, and a controller 340.

The communication unit 310 communicates with a door lock installed in the door. The communication unit 310 may communicate with the door lock through a wired or wireless network. The communication unit 310 receives detection information, etc. detected by the door lock, and transmits a control signal to the door lock. The communication unit 310 may communicate encrypted information including the unique information of the door lock. The communication unit 310 receives detection information from the door lock at a predetermined period of time and transmits a control signal obtained by analyzing the detection information to the door lock. The communication unit 310 is capable of communication using a home network equipped with the door lock. The communication unit 310 may be connected to and communicate with an external mobile communication server or an Internet server.

In addition, the communication unit 310 is capable of communicating with a user terminal. The user terminal is a mobile terminal used by the user, and is preferably capable of network communication. The user terminal may include a keypad, a touch screen, an illuminance sensor, a fingerprint sensor, and a position sensor. The communication unit 310 may also receive authentication information transmitted from the user terminal. Herein, a preset application capable of accessing the control server 200 may be installed in the user terminal. The communication unit 310 is capable of two-way communication with the door lock and the user terminal. A reward means such as points, coupons, and cash is paid to the account of the user terminal.

The detection information management unit 320 acquires detection information obtained by detecting the person's approach from the door lock. Herein, a motion detection sensor, a fingerprint sensor, a contact sensor, etc. capable of detecting the person's approach may be provided in the door lock, but the present invention is not limited thereto. The detection information management unit 320 detects in real time whether a person approaches the door lock. Accordingly, the advertisement information may be output to the display unit of the door lock when a person approaches. When detection information is acquired, the detection information management unit 320 outputs the detection information to the controller 340.

The advertisement information management unit 330 manages the advertisement information output to the display unit of the door lock. The advertisement information is content including at least one of a video, audio, and image uploaded by an advertiser. The advertisement information may be randomly output according to user setting or output in a customized manner to the user using the door lock. The advertisement information management unit 330 may update and provide the advertisement information when the user's approach is detected and the door lock is unlocked. The advertisement information management unit 330 may change and provide the advertisement information according to the location where the door lock is installed, the time when the door lock is installed, the user who installs the door lock, and the like.

In addition, when the user requests additional information about the advertisement information, the advertisement information management unit 330 may provide a URL for providing the additional information to the user terminal. The URL is to provide the additional information because the time when the advertisement information is displayed through the door lock is short. For example, an interface for requesting the additional information may be included in the advertisement information. When the user clicks the interface, a URL of the additional information may be provided to a preset account of the user terminal through SMS, LMS, and SNS. The user may check the additional information through the URL link.

The controller 340 controls the display unit in such a manner as to output preset advertisement information. The advertisement information is determined on the basis of location information of the door lock. The controller 340 may use location information of a network subscription network to which the corresponding door lock belongs, or recognize location information based on an address value input from an application installed in the user terminal. Herein, the location information of the door lock may be set in such a manner that detailed address information is not input to protect personal information.

The controller 340 designates nearby advertisers and outputs the corresponding advertisement information according to the location information of the door lock. Herein, the controller 340 may be set in such a manner as to automatically output the advertisement information according to the location information to the door lock. The controller 340 may receive user information from a user terminal to correspond the user information to the advertisement information on the basis of user's gender, age, and preference information. For example, in the case of a student, advertisement information related to education may be displayed, such as an academy advertisement.

In addition, the controller 340 compares the first location information of the door lock with the second location information of the user terminal. The controller 340 designates the advertisement information on the basis of the first location information, when the first location information and the second location information are within a predetermined range. Meanwhile, the controller 340 may designate the advertisement information on the basis of the second location information when the first location information and the second location information are not within the predetermined range. This is to more accurately set the location information of the door lock when the network is unstable.

In addition, the controller 340 may analyze the user's preference by performing data mining on the usage record of the user terminal, and update the advertisement information according to the preference. Herein, it is possible to classify a type of a product that the user prefers by analyzing the user's Internet search record, call record, etc. through an application installed in the user terminal. The controller 340 may designate an advertisement associated with a product that the user prefers to be output to the door lock as advertisement information.

In addition, the controller 340 outputs a lock screen to the display unit when a user attempts to unlock the door lock. Herein, the user may be allowed to output the lock screen using a touch sensor or a contact sensor provided in the door lock. The lock screen may be automatically output after the advertisement information ends. The lock screen may be in the form of a number key input or a touch pattern input, but is not limited thereto. For example, the lock screen may be implemented as an interface capable of recognizing a user's fingerprint, voice, iris, or face.

In addition, the controller 340 may output an identification code on the lock screen. The identification code is formed in the type of a barcode, a QR code, and an AR code, but is not limited thereto. When the user terminal acquires an identification code and transmits the same together with the authentication information, the controller 340 performs a validity check on the identification code and authentication information. The controller 340 unlocks the door lock when the identification code and authentication information transmitted from the user terminal are valid. Here, the authentication information may include a unique identification number of the user terminal, a mobile communication number, and fingerprint information. Accordingly, the user may unlock the door lock without entering a password into the door lock, thereby reducing the risk of shoulder surfing and enhancing security.

In addition, the controller 340 is also capable of linking the advertisement information of the door lock to the user terminal. For example, when the advertisement information of the door lock is terminated and the door lock is unlocked, the advertisement information is output to the user terminal of a user who is approaching. In the case of an advertisement of 1 minute, when the user is capable of performing the unlocking procedure in 5 seconds, the advertisement of the remaining 55 seconds may be transmitted to the user terminal so that the user is capable of continuously viewing. Accordingly, even when the advertisement is exposed to the door lock for a short time, the advertisement may be continuously exposed to the user terminal.

Meanwhile, the digital door lock control server 300 according to an embodiment of the present invention may further include a reward unit 350.

The reward unit 350 pays a preset reward means to a user account of the door lock according to the number of times that the advertisement information is provided. Here, the reward means comprehensively includes any form capable of being used for money, such as cash, points, coupons, and virtual currency. The reward unit 350 counts the number of times the advertiser's advertisement information is output from the corresponding door lock, and differentially pays the reward means. For example, as the number of times the advertisement information is output increases, a total amount paid as the reward means increases. Herein, the reward unit 350 is connected to an external financial server, an Internet server, and the like.

Herein, the controller 340 pays a predetermined fee to the user account of the door lock when the advertisement information is terminated and the lock screen is released. The controller 340 may perform a validity check to detect whether the advertisement information is effectively output from the corresponding door lock. For example, when the door lock is unlocked within a predetermined time after the advertisement information is displayed, the payment of the reward means may be canceled. Accordingly, it is possible to avoid a situation where the advertisement information is just displayed on the door lock without the user actually watching the advertisement information.

In addition, the controller 340 may differentially pay the reward means according to the time that the advertisement information is output. For example, in the case of an advertisement for 1 minute, points are differentially paid, such as 10 points when the unlocking procedure is performed within 5 seconds, 20 points for 6-30 seconds, 30 points for 31-60 seconds, and so on. The controller 340 may pay an additional reward means when the advertisement information is continuously output in the user terminal, in the case that some of the advertisement information is transmitted to the user terminal so that the user is capable of continuous viewing. This is to compensate a case that the advertisement is briefly exposed in the door lock but the user additionally views the advertisement through the user terminal.

Meanwhile, the digital door lock control server 300 according to an embodiment of the present invention may further include an analysis unit 360. The analysis unit 360 may generate analysis information on the number of times the advertisement information is viewed and the location where the advertisement information is viewed and provides the analysis information to the advertiser. The analysis unit 360 may generate an electronic map to display and provide exposure information of advertisement information for each location. In this case, the analysis unit 360 may generate analysis information by corresponding the position where the door lock is installed to order information of the advertiser's advertisement product. For example, in the case of Pizza A, using analysis information, such as the number of advertisement exposures in apartment B is 50 times a day, and the order quantity is 10 times a day before the advertisement and 20 times a day after the advertisement, it may be determined whether the advertising information actually leads to an increase in sales.

Meanwhile, the digital door lock control server 300 according to an embodiment of the present invention may further include a game unit 370. The game unit 370 may output game information on the lock screen to induce the unlocking procedure. For example, the game information may be implemented in various forms such as common sense of current affairs, English problems, math problems, quizzes, and hidden objects. The game information may be set by the user through the user terminal. This may be set by a user who has a representative administrator authority among members. After the advertisement information is output, the game information is displayed on the lock screen, and when the mission is completed, the door lock is unlocked. For example, in the case that the game information is output in the form of a quiz “What date is the wedding anniversary?”, the door lock is unlocked when the user enters the date using the keypad. Accordingly, the user may be interested in unlocking the door lock.

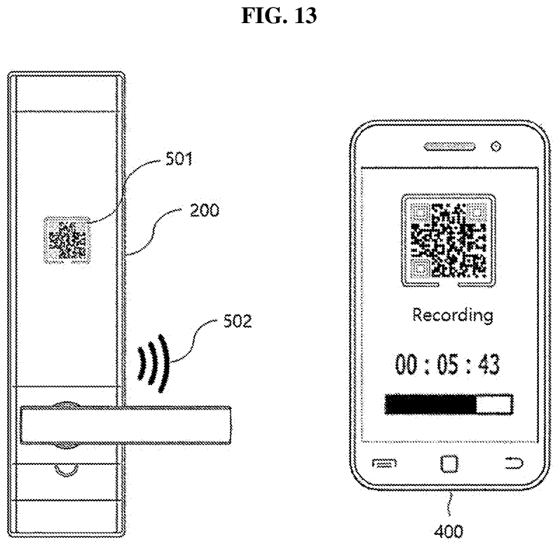

FIG. 13 is an exemplary view showing identification codes of the door lock and the user terminal recognized from the door lock control server for advertisements according to FIG. 12.

Referring to FIG. 13, the identification code 501 may be output to the door lock, and sound wave information 502 may be output to the door lock. The identification code 501 may be output in the form of a barcode, a QR code, or an AR code. The sound wave information 502 has a predetermined frequency of ultrasonic wave signal. The user terminal acquires the identification code 501 with the camera and records the sound wave information 502 to transmit the same to the control server. Herein, the identification code 501 and the sound wave information 502 may be randomly changed. When the identification code 501 and sound wave information 502 are matched with the unique information of the user terminal, the control server determines that a user is a true user to permit the door lock to be unlocked. In the case of a door lock installed in a restricted security area, user authentication may be reinforced.

The present invention has been described above with reference to the drawings, but is not limited thereto. Therefore, the present invention should be interpreted by the description of the claims intended to cover obvious modifications that can be derived from the described embodiments.

What is claimed is:

1. A digital door lock, comprising:
a driving unit formed in a door to move a deadbolt by an electric signal;
a detection unit detecting whether the door is opened or closed; and
a controller configured to allow power to be provided from an external constant power supply when the deadbolt is drawn out of a body and is in contact with a power board inside a bracket formed in a door frame, and allow power to be provided from an internal power supply in a form of a primary battery or a secondary battery when the deadbolt is drawn into the body and is away from the power board.

2. The digital door lock of claim 1, wherein the bracket is configured to have a first insertion hole into which the deadbolt is inserted formed on a first side surface, a second insertion hole into which the deadbolt is inserted formed on a second side surface perpendicular to the first side surface, and a plurality of partition walls formed inside, and
wherein the partition wall is formed with a first seating groove in which the power board is seated to face the first insertion hole and a second seating groove in which the power board is seated to face the second insertion hole.

3. The digital door lock of claim 1, wherein the controller is configured to output a failure signal when power is not supplied from the constant power supply through the deadbolt or when power is not supplied from the internal power supply in a case that the door is locked.

4. The digital door lock of claim 1, further comprising:
a communication unit communicating with an external user terminal or a management server,
wherein the controller is configured to output life information including at least one piece of information of weather information, traffic information, and schedule information from the user terminal or the management server and, when the user approaches, update the living information.

5. The digital door lock of claim 1, further comprising:
a communication unit communicating with an external user terminal or a management server; and
a camera capturing an indoor space or an outdoor space,
wherein the controller is configured to acquire an indoor or outdoor image using the camera when the door is closed, and acquire an indoor or outdoor image through the user terminal when the door is opened.

6. A door lock installed in a door, the door lock comprising:
a detection unit detecting a person's approach;
a display unit outputting advertisement information; and
a controller configured to automatically output the advertisement information to the display unit when the person's approach is detected from the detection unit, and output a lock screen to the display unit when attempting to unlock the door lock.

7. The door lock of claim 6, wherein the detection unit detects the persons' approach using at least one of a motion detection sensor, a fingerprint sensor, and a contact sensor.

8. The door lock of claim 6, further comprising:
a communication unit communicating with an external control server,
wherein the controller is configured to receive an identification code from the control server and output the identification code to the lock screen and, when the user terminal obtains the identification code and transmits the same to the control server together with authentication information to be authenticated, unlock the door lock.

9. The door lock of claim 6, further comprising:
a location providing unit providing location information of the door lock,
wherein the controller is configured to update the advertisement information according to the location information of the door lock and output a reward means to the display unit.

10. A digital door lock control server, comprising:
a communication unit communicating with a door lock installed in a door;
a detection information management unit acquiring detection information obtained by detecting a person's approach from the door lock;
an advertisement information management unit managing advertisement information displayed on a display unit of the door lock; and
a controller configured to output the advertisement information to the display unit when the person's approach is confirmed from the detection information and display a lock screen on the display unit when attempting to unlock the door lock.

11. The digital door lock control server of claim 10, further comprising:
a reward unit paying a predetermined reward means to a user account of the door lock according to the number of times the advertisement information is provided,
wherein the controller is configured to pay a predetermined fee to the user account of the door lock when the advertisement information is terminated and the lock screen is released.

12. The digital door lock control server of claim 10, wherein the advertisement information management unit is configured to update the advertisement information according to the location information of the door lock and, when a user requests additional information about the advertisement information, provide an URL for the additional information to the user terminal.

13. The digital door lock control server of claim 10, further comprising:
an analysis unit generating analysis information on a number of times the advertisement information is viewed and a location where the advertisement information is viewed and providing the analysis information to an advertiser.

14. A digital door lock system, comprising:
a digital door lock installed in a door; and
a control server including a communication unit communicating with the door lock, a detection information management unit acquiring detection information obtained by detecting a person's approach from the door lock, an advertisement information management unit managing advertisement information displayed on a display unit of the door lock, and a controller configured to output the advertisement information to the display unit when the person's approach is confirmed from the detection information and display a lock screen on the display unit when attempting to unlock the door lock.
